(19) United States
(12) Patent Application Publication
(10) Pub. No.: US 2003/0034110 A1
(43) Pub. Date: Feb. 20, 2003

(54) Method and device for producing an adhesive-bonded connection between a semiconductor wafer and a carrier plate

(75) Inventors: Thomas Hubel, Kraiburg/Inn (DE); Hubert Danner, Traunreut (DE); Armin Mauler, Altenmarkt/Alz (DE); Klaus Rottger, Bachmehring (DE)

Correspondence Address: WILLIAM COLLARD, COLLARD & ROE, P.C., 1077 NORTHERN BOULEVARD, ROSLYN, NY, 11576, US

(73) Assignee: Wacker Siltronic Gesellschaft fur Halbleitermaterialien AG

(21) Appl. No.: 10/213,522

(22) Filed: Aug. 7, 2002

(30) Foreign Application Priority Data
Aug. 16, 2001 (DE) 101 40 133.7

(51) Int. Cl. B32B 31/00

(52) U.S. Cl. 156/60; 156/285; 156/156

(57) ABSTRACT

A method and device for producing an adhesive-bonded join between a semiconductor wafer and a carrier plate, the semiconductor wafer being held at a distance above the carrier plate and being convexly deformed by an elastic wall of an inflatable pressure chamber, then being laid onto the carrier plate, enclosing an adhesive substance, and is joined in a nonpositively locking manner to the carrier plate. An edge region of the semiconductor wafer is sucked up and held above the carrier plate, the suction is ended and the semiconductor wafer is allowed to drop in a convexly deformed state onto the carrier plate, and only a central area of the semiconductor wafer is pressed onto the carrier plate by the elastic wall of the pressure chamber.

### BACKGROUND OF THE INVENTION

1. Field of the Invention

The invention relates to a method for producing an adhesive-bonded connection between a semiconductor wafer and a carrier plate. The invention relates in particular to a method in which a semiconductor wafer is fixed on a carrier plate preparatory to single-side polishing. The invention also relates to a device which is suitable for carrying out the method.

2. The Prior Art

Polishing generally represents the final working step by which unevenness which has remained on the sides of the semiconductor wafer is eliminated. This unevenness originates from the preceding working steps, such as lapping or grinding, which are used to shape the semiconductor wafers. The desired end product is a semiconductor wafer with surfaces which are as flat and plane-parallel as possible and which is suitable for the fabrication of electronic components. The flatness criteria which need to be adhered to are becoming ever more demanding. One of these criteria is what is known as the nanotopology, in which the waviness, which is expressed as short-wave slopes with height differences in the range of up to 50 nm, is considered. Since polishing is a working step which has a particular influence on the nanotopology, proposals aimed at optimizing this working step have already been disclosed.

In Japanese Patent No. JP 11-245163, it is proposed that a central area of the semiconductor wafer be placed onto the carrier plate, under the influence of a vacuum, and then be pressed onto the carrier plate. The intention is for the semiconductor wafer to be adhesively bonded to the carrier plate without any air inclusions being formed. Japanese Patent No. JP 2000-127034 deals with the same objective, the proposed solution being for the semiconductor wafer to be placed onto the carrier plate and for an inflatable cushion to be used to press first the central area and ultimately the entire surface of the semiconductor wafer onto the carrier plate.

### SUMMARY OF THE INVENTION

It is an object of the present invention to achieve a further improvement over the prior art, resulting in a low waviness of the polished semiconductor wafer.

The invention relates to a method for producing an adhesive-bonded connection between a semiconductor wafer and a carrier plate, the semiconductor wafer being held at a distance above the carrier plate and being convexly deformed by an elastic wall of an inflatable pressure chamber. The wafer is then laid onto the carrier plate, enclosing an adhesive substance, and is joined in a nonpositively locking manner to the carrier plate, wherein an edge region of the semiconductor wafer is sucked up and held above the carrier plate. The suction applied to the semiconductor wafer is then ended and the semiconductor wafer is allowed to drop in a convexly deformed state onto the carrier plate, and only a central area of the semiconductor wafer is pressed onto the carrier plate by the elastic wall of the pressure chamber.

It has been found that the way in which the semiconductor wafer is placed onto the carrier plate is of particular importance. Surprisingly, less favorable nanotopology parameters are to be expected if a vacuum is used to suck the semiconductor wafer onto the carrier plate, even if the semiconductor wafer is sucked on with a convex deformity in order for the air between the carrier plate and the semiconductor wafer to be displaced radially outward. According to the invention, it is proposed for the semiconductor wafer to be allowed to drop onto the carrier plate in a convexly deformed state and for initially only a central area of the wafer to be pressed onto the carrier plate. In this state, the semiconductor wafer is fixed against slipping, in a nonpositively locking manner, on the carrier plate only by means of the central area. The remaining area of that surface of the semiconductor wafer which faces toward the carrier plate merely rests on the carrier plate and the substance which is intended to create the adhesive-bonded join. Fixing of the semiconductor wafer to the carrier plate over the entire surface only takes place at a later time.

The adhesive substance is applied either to the carrier plate or to that surface of the semiconductor wafer which is to be fixed before the semiconductor wafer is placed onto the carrier plate, preferably by spin-coating with the substance in the form of a film or by the application of small islands of the substance by means of screen printing. The latter option is described in the as yet unpublished German patent application bearing the application number 100 54 159.3 and is particularly preferred.

The invention also relates to a device which is suitable for carrying out the claimed method. A device of this type has means for sucking up the semiconductor wafer in an edge region, and height-adjustable supports for holding the semiconductor wafer at a distance above the carrier plate, as well as an inflatable pressure chamber with an elastic wall for converting the semiconductor wafer into a convex shape and for pressing a central area of the semiconductor wafer onto the carrier plate.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIGS. 1 and 2 show a side view of the inventive positioning of a semiconductor wafer at the start and the end of the method using a first, preferred device;

FIGS. 3 and 4 show the inventive positioning of a semiconductor wafer at the start and end of the method using a second, equally preferred device;

FIGS. 5 and 6 show images which originate from an examination of the nanotopology of semiconductor wafers; and

FIG. 7 shows a side view of yet another embodiment of the invention.

### DETAILED DESCRIPTION OF THE PREFERRED EMBODIMENTS

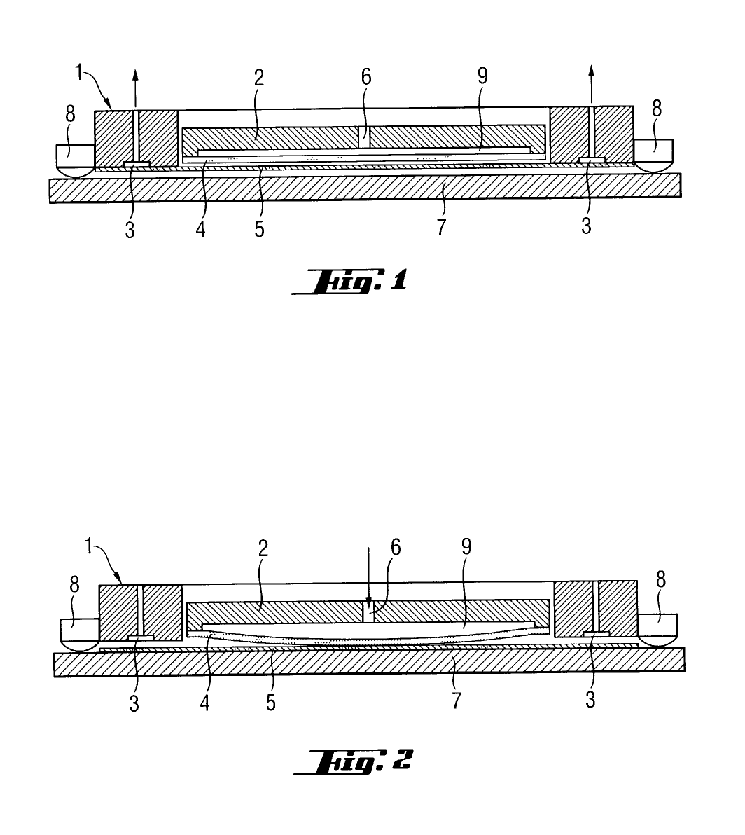

Referring now in detail to the drawings, the device shown in FIGS. 1 and 2 is a wafer holder 1 which is designed in the form of a ring (a ring chuck), onto the underside of which it is possible to suck a semiconductor wafer 5. For this purpose, passages 3, which can be evacuated and vented, are provided in the wafer holder. The diameter of the wafer holder is such that the semiconductor wafer 5 can be sucked up in an edge region. The wafer holder 1 expediently consists of metal or plastic. In its center, there is an inflatable pressure chamber 9, which according to the embodiment illustrated is formed by a support 2 and a wall 4 made from elastically deformable material, preferably silicone. The wall material preferably has a Shore A hardness of 10 to 50. The pressure chamber can be inflated and deflated via a line 6 in the support. In the inflated state, a pressure of 1 to 20 mbar preferably prevails in the pressure chamber. To inflate the pressure chamber, a gas, for example air, or a liquid, for example water, is allowed to flow in through the line, during which time wall 4 is stretched and curves outward. In the process, a semiconductor wafer 5 which has been sucked onto wafer holder 1 is convexly deformed. The distance between semiconductor wafer 5 which has been sucked up and a carrier plate 7 can be set with accuracy by means of a plurality of height-adjustable supporting feet 8, which preferably consist of an abrasion-resistant material. The distance between the sucked-up, as yet undeformed semiconductor wafer 5 and the carrier plate 7, without taking account of the thickness of the adhesive substance, is preferably from 0.1 to 10 mm, particularly preferably from 0.3 to 1.5 mm.

There are preferably three height-adjustable supporting feet 8, which form a three-point support for wafer holder 1. The supporting feet are adjusted in such a manner that semiconductor wafer 5 is held parallel to the surface of carrier plate 7 after it has been sucked up. Then, a fluid is allowed to flow through line 6 into the pressure chamber, causing wall 4 and sucked-up semiconductor wafer 5 to be convexly deformed. It is preferred, although not absolutely imperative, for there to be a clear gap between semiconductor wafer 5 and carrier plate 7 before semiconductor wafer 5 is dropped onto carrier plate 7. When it is dropped, initially a central area of semiconductor wafer 5, and then an edge area come into contact with carrier plate 7, and, as shown in FIG. 2, the central area is pressed onto carrier plate 7 by the elastic wall 4 of the pressure chamber. The remaining surface of that side of semiconductor wafer 5 which faces carrier plate 7 is merely resting on carrier plate 7. In this area, there is as yet no nonpositively locking connection between semiconductor wafer 5 and carrier plate 7. The adhesive substance which is enclosed between the semiconductor wafer 5 and carrier plate 7 only produces a connection of this type at locations where semiconductor wafer 5 has been pressed onto carrier plate 7.

The semiconductor wafer 5 which has been fixed on carrier plate 7 at a central area is then pressed onto the carrier plate 7 over the entire area, in order to create a nonpositively locking connection over the entire surface of semiconductor wafer 5. According to one configuration of the invention, this can take place using a method which forms part of the prior art. According to another, preferred configuration of the invention, semiconductor wafer 5 is pressed onto carrier plate 7 by a cushion which consists entirely of a soft, elastic plastic with a Shore A hardness of preferably 1 to 50 and has a convex shape. A preferred material is a silicone having the corresponding properties.

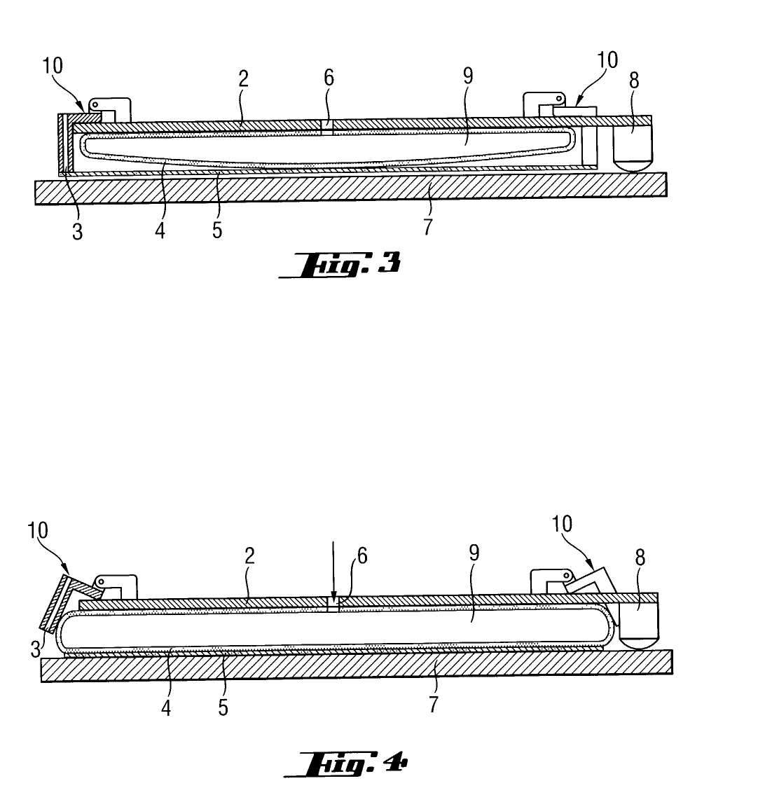

According to a further, equally preferred embodiment, semiconductor wafer 5 is pressed onto carrier plate 7 over the entire area with the aid of the device which is illustrated in FIGS. 3 and 4. Compared to the device shown in FIGS. 1 and 2, the device illustrated in FIGS. 3 and 4 additionally has features which allow the semiconductor wafer to be pressed onto the carrier plate immediately after the same device has been used to place the wafer onto the carrier plate. The suction passages 3 for sucking up semiconductor wafer 5 in an edge region are accommodated in segments 10 which can be pivoted away outward. In the embodiment illustrated, inflatable pressure chamber 9 is designed as an elastic cushion which is secured to a support 2 and can be inflated as a result of a fluid being supplied through line 6 in support 2. Semiconductor wafer 5 is placed onto carrier plate 7 in the manner which has already been discussed above, a process which ends when a wall 4 of the cushion presses a central area of semiconductor wafer 5 onto the carrier plate. Then, the entire surface of the semiconductor wafer 5 is pressed onto the carrier plate as a result of the cushion 4 being inflated further, until it covers and applies pressure to the whole of semiconductor wafer 5, i.e. including in the edge region. During this operation, the segments 10 for sucking up the semiconductor wafer are pivoted away outward.

For the invention to be successful, it is not important whether a semiconductor wafer is placed onto a carrier plate on its own or at the same time as a plurality of additional semiconductor wafers. However, for economic reasons it is preferable for a plurality of semiconductor wafers to be processed simultaneously. For this purpose, a number of claimed devices are combined to form a single unit.

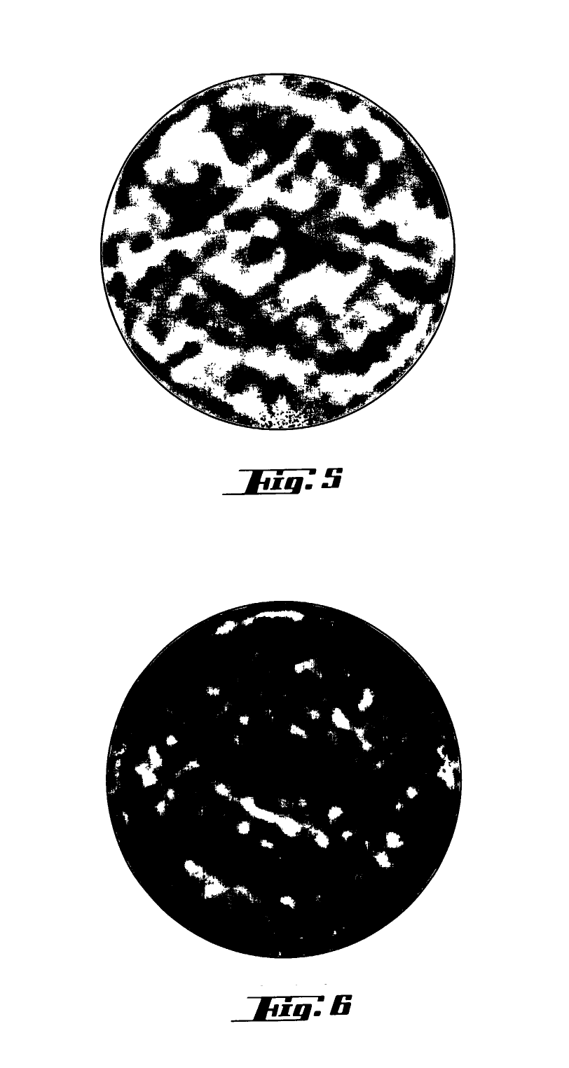

FIGS. 5 and 6 show images which originate from an examination of the nanotopology of semiconductor wafers. The semiconductor wafer shown in FIG. 5 had been placed onto a carrier plate in a convexly deformed state without the application of a vacuum and had been pressed onto the carrier plate in a manner according to the invention, and then polished in a manner according to the prior art. By contrast, the semiconductor wafer shown in FIG. 6 was under the influence of a vacuum when it was placed onto the carrier plate, so that the convexly deformed semiconductor wafer was pulled onto the carrier plate. The appearance of the image shown in FIG. 5, which has a recognizably lower contrast, indicates lower nanotopology defects, and a difference in the flatness values of 15.8% was quantified. The improved flatness values which are expected to result from application of the invention can be explained by the fact that placing the semiconductor wafer onto the carrier plate in accordance with the invention makes it possible to avoid inclusions of air between the semiconductor wafer and the carrier plate to an extent which has not hitherto been possible.

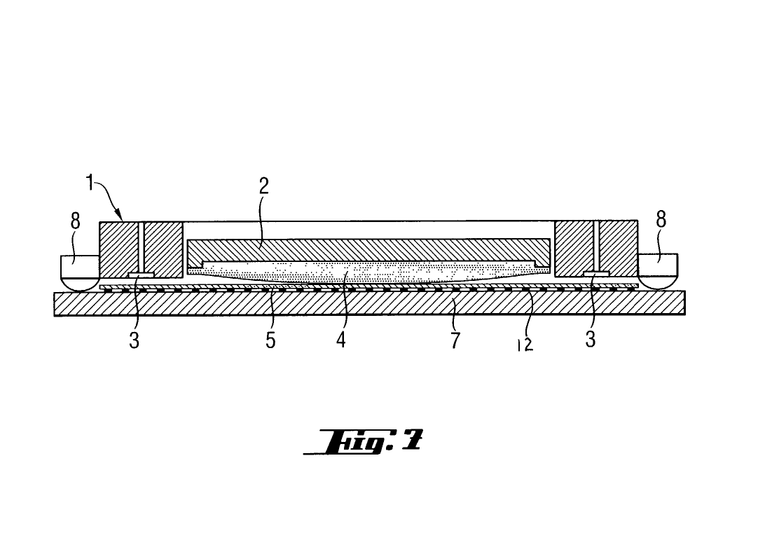

FIG. 7 shows an embodiment in which the entire surface of semiconductor wafer 5 is pressed onto carrier plate 7 by a cushion 4 which has a convex shape and is produced entirely from a soft, elastic plastic, rather than being inflatable as with the embodiment of FIG. 5. Wafer 5 is held to carrier plate 7 by a layer of adhesive 12, which is applied in the form of spaced-apart islands between wafer 5 and carrier plate 7.

Accordingly, while only a few embodiments of the present invention have been shown and described, it is obvious that many changes and modifications may be made thereunto without departing from the spirit and scope of the invention.

What is claimed is:

1. A method for producing an adhesive-bonded connection between a semiconductor wafer and a carrier plate, comprising:
holding the semiconductor wafer at a distance above the carrier plate by suction applied to an edge region of the semiconductor wafer;
convexly deforming the semiconductor wafer with an elastic wall of an inflatable pressure chamber;
laying the semiconductor wafer onto the carrier plate enclosing an adhesive substance between the wafer and the carrier plate, said step of laying accomplished by ending the suction and allowing the semiconductor wafer to drop in a convexly deformed state onto the carrier plate; and
joining the semiconductor wafer in a nonpositively locking manner to the carrier plate by pressing only a central area of the semiconductor wafer onto the carrier plate with the elastic wall of the pressure chamber.

2. The method as claimed in claim 1, wherein ultimately an entire surface of the semiconductor wafer is pressed onto the carrier plate as a result of the pressure chamber being inflated further.

3. The method as claimed in claim 1, wherein ultimately an entire surface of the semiconductor wafer is pressed onto the carrier plate by a cushion which has a convex shape and is produced entirely from a soft, elastic plastic.

4. The method as claimed in claim 1, wherein the adhesive substance is enclosed in the form of spaced-apart islands between the semiconductor wafer and the carrier plate.

5. A device for placing a semiconductor wafer onto a carrier plate, comprising:
a device for sucking up an edge region of the semiconductor wafer;
height-adjustable supports for holding the semiconductor wafer at a distance above the carrier plate; and
an inflatable pressure chamber with an elastic wall for converting the semiconductor wafer into a convex shape and for pressing a central area of the semiconductor wafer onto the carrier plate.

6. The device as claimed in claim 5, wherein the device for sucking up the edge region of the semiconductor wafer is designed in such a manner that said device can be pivoted outward away from the edge region of the semiconductor wafer.
